(19) United States
(12) Patent Application Publication
(10) Pub. No.: US 2024/0179573 A1
(43) Pub. Date: May 30, 2024

(54) INFORMATION TRANSMISSION METHOD, NETWORK NODE, CONTROLLER, AND STORAGE MEDIUM

(71) Applicant: ZTE CORPORATION, Shenzhen (CN)

(72) Inventors: Ran CHEN, Shenzhen (CN); Shaofu PENG, Shenzhen (CN); Min XIAO, Shenzhen (CN)

(21) Appl. No.: 18/552,483

(22) PCT Filed: Mar. 8, 2022
(86) PCT No.: PCT/CN2022/079731

§ 371 Date: Sep. 26, 2023

(30) Foreign Application Priority Data
Mar. 26, 2021 (CN) 202110326816.3

(51) Int. Cl. H04W 28/16; H04L 41/40

(52) U.S. Cl. CPC H04W 28/16; H04L 41/40

(57) ABSTRACT

Provided are an information transmission method and apparatus, a network node, a controller and a storage medium. The method is applied to a network node and includes: acquiring slice-associated resource information for each link in a network and transmitting the resource information.

### TECHNICAL FIELD

The present application relates to the technical field of communications, for example, an information transmission method and apparatus, a network node, a controller and a storage medium.

### BACKGROUND

The fifth-generation mobile communication technology (5G) poses challenges to a bearer network to satisfy the demands of low latency, flexible scheduling and massive connections, and slicing is one of the key technologies. Through the slicing technology, 5G network resources may be flexibly segmented to quickly customize virtual networks satisfying differentiated demands of customers, while the network resources are fully shared to achieve a dynamic balance between on-demand customization and network creation cost.

With the continuous search on the network slicing technology, slicing solutions based on the Internet Protocol (IP)/Multiprotocol Label Switching (MPLS) include an interior gateway protocol (IGP) Flexible Algorithm (that is, Flex-Algo) and a slice aggregation solution. IGP Flex-Algo may be used as a method to create a virtual topology (or a logic network or known as a Flex-Algo plane) in a physical network, that is, to create multiple Flex-Algo planes containing different nodes and link resources by running multiple IGP algorithms in the same physical topology, and overlay service traffic may be carried on different Alex-Algo planes (that is, different overlay networks). Each Flex-Algo plane is identified by its corresponding algorithm value. The each FA plane (that is, Flex-Algo plane) may correspond to a slice. The slice aggregation solution has proposed to create slices again based on a virtual Flex-Algo topology and to use slice aggregation identifiers (SA-ID) to identify the slices. If the scale of slices-to-be-created is very large in the network, for example, the scale exceeds the maximum number (such as 128) that can be represented by the IGP Flex-Algo algorithm, new slice identifiers (such as slice aggregation identifiers) must be introduced into the network (including a control plane and a forwarding plane) to distinguish resource management strategies and packet forwarding strategies for different slices.

However, topological information collected in the related art is link-based topological information including a delay, a bandwidth and a packet loss rate of a link. It is not convenient to manage and control slices in the network based on the existing topological information.

### SUMMARY

The present application provides an information transmission method and apparatus, a network node, a controller and a storage medium to facilitate management and control of slices in a network.

An embodiment of the present application provides an information transmission method. The method is applied to a network node and includes the steps below.

Slice-associated resource information for each link in a network is acquired.

The resource information is transmitted.

An embodiment of the present application provides an information transmission method. The method is applied to a controller and includes the steps below.

Slice-associated resource information for each link in a network is acquired.

The resource information is stored.

An embodiment of the present application provides an information transmission apparatus. The apparatus is configured in a network node and includes an acquisition module and a transmission module.

The acquisition module is configured to acquire slice-associated resource information for each link in a network.

The transmission module is configured to transmit the resource information.

An embodiment of the present application provides an information transmission apparatus. The apparatus is configured in a controller and includes an acquisition module and a storage module.

The acquisition module is configured to acquire slice-associated resource information for each link in a network.

The storage module is configured to store the resource information.

An embodiment of the present application provides a network node. The network node includes at least one processor and a storage apparatus.

The storage apparatus is configured to store at least one program.

When executed by the at least one processor, the at least one program cause the at least one processor to perform the method according to any one of embodiments of the present application.

An embodiment of the present application provides a controller. The controller includes at least one processor and a storage apparatus.

The storage apparatus is configured to store at least one program.

When executed by the at least one processor, the at least one program cause the at least one processor to perform the method according to any one of embodiments of the present application.

An embodiment of the present application provides a storage medium storing a computer program which, when executed by a processor, causes the processor to perform any method according to embodiments of the present application.

The preceding embodiments and other aspects of the present application and implementations thereof are described in more detail in the brief description of drawings, detailed description, and claims.

### BRIEF DESCRIPTION OF DRAWINGS

FIG. 1 is a flowchart of an information transmission method according to an embodiment of the present application.

FIG. 2 is a diagram illustrating the structure of a system according to an embodiment of the present application.

FIG. 3 is a flowchart of another information transmission method according to an embodiment of the present application.

FIG. 3A is a diagram illustrating a maximum reserved link bandwidth type-length-value (TLV) according to an embodiment of the present application.

FIG. 3B is a diagram illustrating another maximum reserved link bandwidth TLV according to an embodiment of the present application

FIG. 3C is a diagram illustrating a used bandwidth information TLV according to an embodiment of the present application.

FIG. 3D is a diagram illustrating an available link bandwidth TLV according to an embodiment of the present application.

FIG. 3E is a diagram illustrating resource allocation according to an embodiment of the present application.

FIG. 4 is a diagram illustrating the structure of an information transmission apparatus according to an embodiment of the present application.

FIG. 5 is a diagram illustrating the structure of another information transmission apparatus according to an embodiment of the present application.

FIG. 6 is a diagram illustrating the structure of a network node according to an embodiment of the present application.

FIG. 7 is a diagram illustrating the structure of a controller according to an embodiment of the present invention.

### DETAILED DESCRIPTION

Embodiments of the present application are described hereinafter in conjunction with drawings. The steps illustrated in the flowcharts among the drawings may be performed by, for example, a computer system capable of executing a set of computer-executable instructions. Moreover, although logical sequences are illustrated in the flowcharts, in some cases, the illustrated or described steps may be performed in sequences different from those described herein.

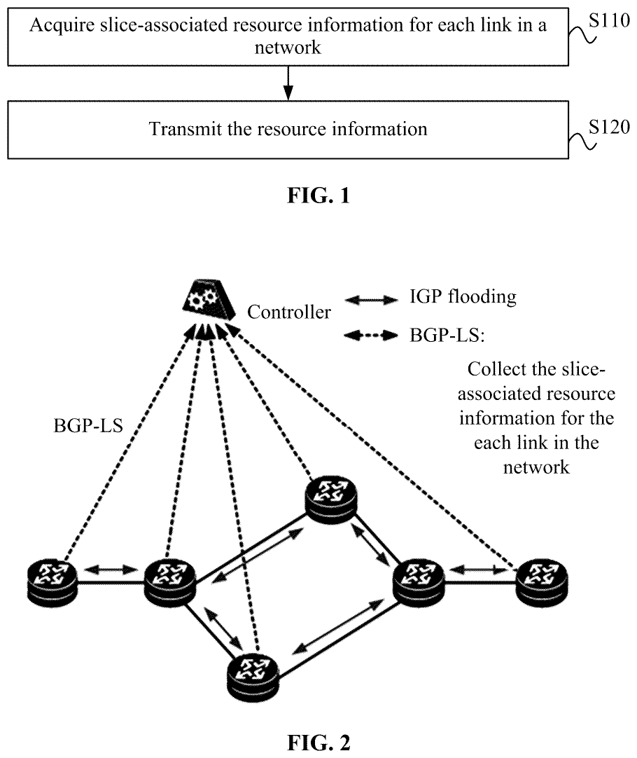

In an exemplary embodiment, FIG. 1 is a flowchart of an information transmission method according to an embodiment of the present application. The method is applicable to the case of improving the convenience of slice management and control in a network. The method may be executed by an information transmission apparatus according to an embodiment of the present application. The apparatus may be implemented by software and/or hardware and integrated in a network node. The network node may be a communication node in the network. FIG. 2 is a diagram illustrating the structure of a system according to an embodiment of the present application. Referring to FIG. 2, the network node may notify a controller of slice-associated resource information for each link through Border Gateway Protocol link state (BGP-LS). Network nodes in the network may acquire the slice-associated resource information through IGP flooding.

As shown in FIG. 1, the information transmission method according to the present application includes the steps below.

In S110, slice-associated resource information for each link in a network is acquired.

For ease of management and control of slices in the network, the network node may acquire the slice-associated resource information for the each link to facilitate unified management by the controller. The network node may be any node in the network.

The mode of acquiring the resource information by the network node is not limited in the embodiment of the present application. For example, the slice-associated resource information on the each link may be acquired through IGP flooding. The resource information may be regarded as information associated with a slice. For example, the resource information may be link information associated with a slice. The link information may be regarded as information representing the state of the each link.

In an embodiment, the resource information includes at least one of: a maximum reserved link bandwidth, an available bandwidth, a used bandwidth, an average link delay, a link packet loss rate, a maximum link delay, or a minimum link delay.

The maximum reserved link bandwidth may be regarded as a maximum link bandwidth reserved for a corresponding slice for a link. The available bandwidth may be regarded as an available bandwidth for a corresponding slice for a link. The used bandwidth may be regarded as a used bandwidth for a corresponding slice for a link. The average link delay may be regarded as an average link delay on a corresponding slice for a link. The maximum link delay may be regarded as a maximum link delay on a corresponding slice for a link. The minimum link delay may be regarded as a minimum link delay on a corresponding slice for a link. The link packet loss rate may be regarded as, for a link, a packet loss rate of the link on a corresponding slice.

In S120, the resource information is transmitted.

After being acquired, the resource information may be transmitted to other nodes, for example, to the other network nodes in the network or notified to the controller, so as to facilitate management and control of slices by the controller based on the resource information.

In an embodiment, in this step, the resource information may be transmitted through BGP-LS, that is, the controller is notified of the resource information.

In the information transmission method according to the present application, the slice-associated resource information for the each link in the network is acquired and transmitted so that management and control of the slices by the controller can be facilitated by notifying the controller of the acquired slice-associated resource information for the each link in the network.

Based on the preceding embodiment, variant embodiments of the preceding embodiment are provided. It is to be noted here that for ease of description, only differences from the preceding embodiment are described in the variant embodiments.

In an embodiment, the resource information includes at least one of: the maximum reserved link bandwidth, the available bandwidth, the used bandwidth, the average link delay, the link packet loss rate, the maximum link delay, or the minimum link delay.

In an embodiment, the resource information is associated with slice information.

In this embodiment, the resource information is associated with the slice information so that a slice corresponding to the resource information can be represented. The slice information may be regarded as slice-associated information such as slice identification information.

In an embodiment, the slice information includes at least one of: a slice aggregation identifier, an algorithm identifier, a multi-topology identifier, or a virtual network identifier.

In an embodiment, the resource information and the slice information are carried in a link attribute TLV extended in link network-layer reachability information (NLRI).

In this embodiment, a new link attribute TLV for carrying the resource information and the slice information may be extended in the link NLRI.

In an embodiment, the slice information is carried in the link attribute TLV extended in the link NLRI, and the resource information is carried in a sub-TLV of the link attribute TLV extended in the link NLRI.

In this embodiment, a new link attribute TLV may be extended in the link NLRI, so the extended link attribute TLV carries the slice information, and a sub-TLV of the extended link attribute TLV carries the resource information.

In an embodiment, the method further includes that in the case where network topological information changes, changed resource information is acquired and transmitted.

The mode of learning the changes in the network topological information is not limited herein. In the case where the network topological information changes, the changed resource information may be acquired through IGP flooding and is then transmitted. When the changed resource information is transmitted, unchanged resource information may also be transmitted together with the changed resource information.

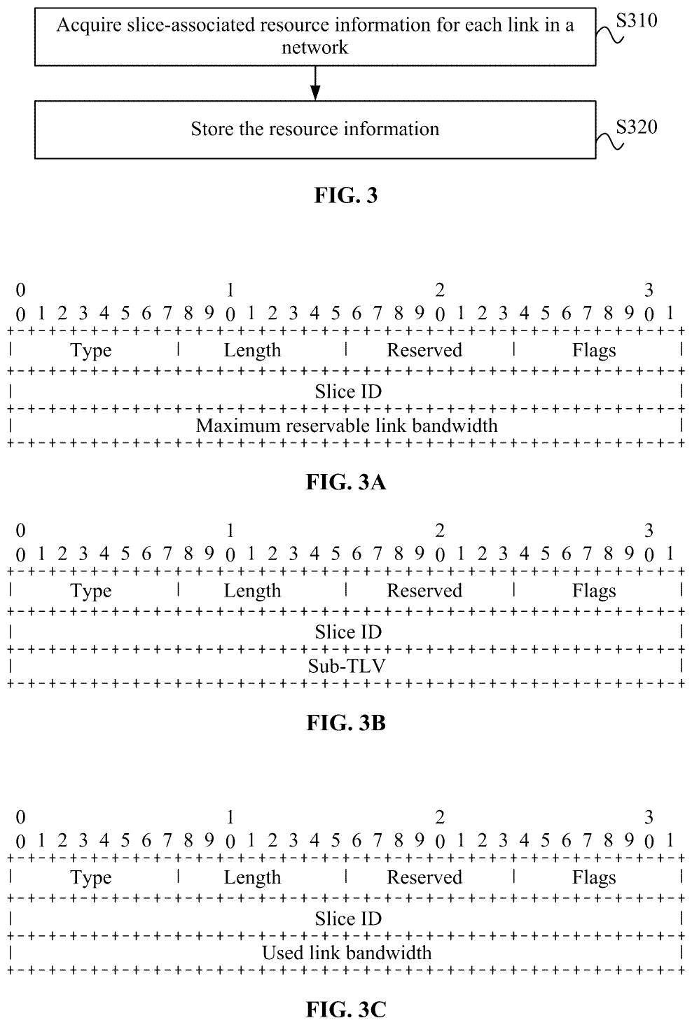

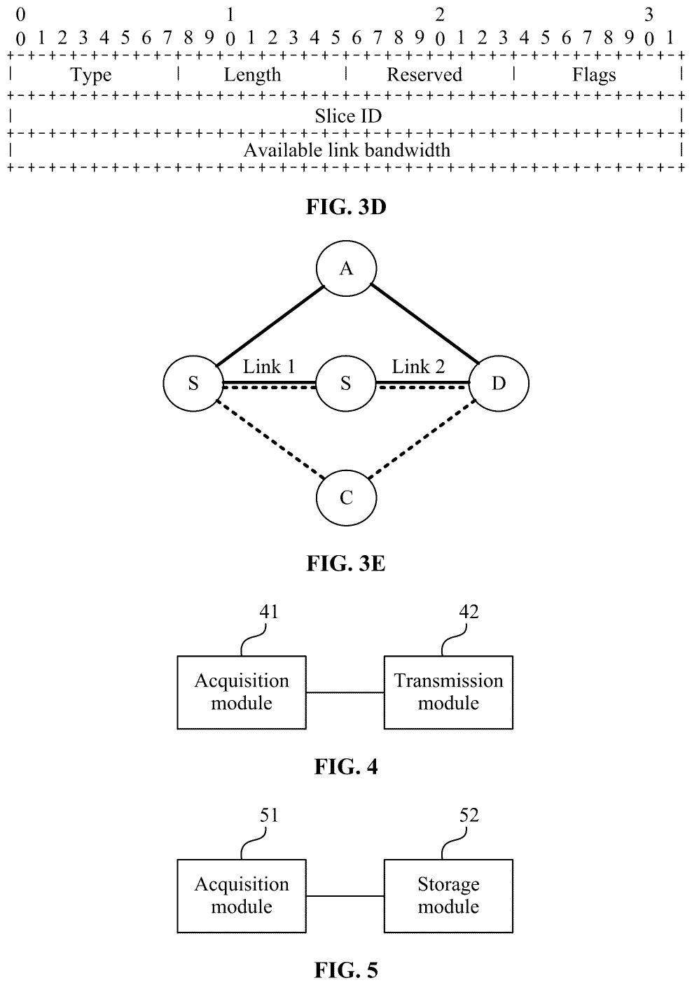

In an exemplary embodiment, the present application further provides an information transmission method. FIG. 3 is a flowchart of another information transmission method according to an embodiment of the present application. The method is applicable to the case of improving the convenience of slice management and slice control in a network. The method may be executed by an information transmission apparatus according to the present application. The apparatus may be implemented by software and/or hardware and integrated in a controller.

As shown in FIG. 3, the information transmission method according to the present application includes the the steps below.

In S310, slice-associated resource information for each link in a network is acquired.

In this step, the resource information transmitted by a network node may be acquired, that is, may be collected. The acquisition mode is not limited herein. For example, the resource information is acquired through the BGP-LS protocol.

In S320, the resource information is stored.

After acquiring the resource information, the controller may store the resource information to facilitate management and control of slices in the network, such as facilitating a subsequent query of the resource information or performing resource allocation based on the resource information.

For the content that is not yet exhaustive in this embodiment, reference may be made to the preceding embodiments. Details are not repeated herein.

In the information transmission method according to the present application, the slice-associated resource information for the each link in the network is acquired and stored so that the slices in the network can be effectively managed and controlled through the acquired resource information.

Based on the preceding embodiment, variant embodiments of the preceding embodiment are provided. It is to be noted here that for ease of description, only differences from the preceding embodiment are described in the variant embodiments.

In an embodiment, the method further includes that changed resource information is acquired, and the stored resource information is updated according to the changed resource information.

After the changed resource information is acquired, the stored resource information may be updated. In the case where the changed resource information is transmitted together with the unchanged resource information, the stored resource information may be directly replaced with the acquired resource information.

In an embodiment, the method further includes that a query request is acquired, and resource information corresponding to the query request is searched for.

Exemplarily, an application module sends the query request to the controller, the controller searches for the resource information corresponding to the query request, and after finding the resource information corresponding to the query request, a control module may transmit the searched resource information to the application module.

The query request may be regarded as a request to query the resource information.

In an embodiment, the method further includes that a deployment request is acquired, resource information corresponding to the deployment request is searched for, and resource allocation is completed based on the searched resource information.

The deployment request may be regarded as a request to deploy resources in the network.

After the corresponding resource information is searched for based on the deployment request, the controller may complete the resource allocation based on the searched resource information, such as path deployment.

In an embodiment, the resource information includes at least one of: a maximum reserved link bandwidth, an available bandwidth, a used bandwidth, a link delay, a link packet loss rate, a maximum link delay, or a minimum link delay.

In an embodiment, the resource information is associated with slice information.

In an embodiment, the slice information includes at least one of: a slice aggregation identifier, an algorithm identifier, a multi-topology identifier, or a virtual network identifier.

In an embodiment, the resource information and the slice information are carried in a link attribute TLV extended in link network-layer reachability information (NLRI).

In an embodiment, the slice information is carried in the link attribute TLV extended in the link NLRI, and the resource information is carried in a sub-TLV of the link attribute TLV extended in the link NLRI.

An exemplary description of the present application is made below.

Users and enterprises have rapidly increasing personalized demands for communication networks and need to customize virtual networks having multiple differentiated service-level agreements (SLAs), so network slicing arises therefrom.

The demands of the users to customize the virtual networks having multiple differentiated SLAs can be satisfied. Through the slicing technology, the 5G network resources may be flexibly segmented to quickly customize the virtual networks satisfying the differentiated demands of the users, while the network resources are fully shared to achieve a dynamic balance between on-demand customization and network creation cost. The network slicing is an inevitable choice for differentiated demands of 5G and is also the basis for transformation of business modes in the 5G era.

The related slicing technologies for making slicing bearers are mainly draft-ietf-lsr-flex-algo (short for IGP Flex-Algo) of Cisco and draft-bestbar-teas-ns-packet (short for slice aggregation) of Juniper. IGP Flex-Algo proposes to generate different Flex-Algo virtual topologies (or known as FA planes) using IGP Flexible Algorithms. The shortest path forwarding behavior in an FA plane, compared with the traditional physical topology or the multi-topology technology in which forwarding is performed always along a path having the minimum IGP metric, adds richer constraints: supporting other types of metrics such as a traffic engineering (TE) metric and a delay metric. In addition, each FA plane may customize its topological elements only containing specified nodes and links. These constraints are included in the Flexible Algorithm Definition (FDA). draft-bonica-lsr-ip-flexalgo-01 continues to discuss how to apply IGP Flex-Algo to a pure Internet Protocol (IP) network without segment routing (SR), enabling flexible algorithm paths to be calculated to the address of the ordinary Internet Protocol version 4 (IPv4) or Internet Protocol version 6 (IPv6).

Draft-ietf-idr-bgp-ls-flex-algo extends topological information used by the controller in the BGP-LS protocol to collect FAD carrying per algorithm. The collected information includes link affinity colors included and excluded in specified path calculation and a prefix metric of a local node, that is, the prefix metric attribute.

The slice aggregation has proposed to create slices again based on a virtual Flex-Algo topology. If the scale of slices-to-be-created is very large in the network, for example, the scale exceeds the maximum number (such as 128) that can be represented by the IGP Flex-Algo algorithm, new slice identifiers (such as slice aggregation identifiers, that is, slice aggregation ID) must be introduced into the network (including a control plane and a forwarding plane) to distinguish resource management strategies and packet forwarding strategies for different slices. Theoretically, after the new slice identifiers are introduced, different slice sub-topologies may be directly divided based on the physical topology, and resources of the different slice sub-topologies may be maintained.

To comprehensively perform path optimization on the service traffic running in each slice in the network and avoid unnecessary traffic congestion, the controller also needs to manage and maintain corresponding bandwidth resource reservation and consumption information for the each slice and use this information for selecting corresponding link resources for a traffic engineering (TE) path of the each slice.

### Embodiment One

A node, that is, the network node, notifies the controller of the maximum reservable link bandwidth associated with a specific slice for the each link in the network through the BGP-LS protocol, such as the maximum reservable link bandwidth associated with a slice for the each link in the network, that is, the maximum reserved link bandwidth. The specific slice is not limited herein. Specific slices may be all the slices in the network or some slices in the network. Division of the some slices is not limited. New link attribute type-length-values, that is, link attribute TL Vs, are defined in the link NLRI for carrying the maximum reservable link bandwidth of the specific slice.

FIG. 3A is a diagram illustrating a maximum reserved link bandwidth TLV according to an embodiment of the present application. As shown in FIG. 3A, the resource information is associated with the slice information in the extended link attribute TLV, and the slice information, such as a slice identifier (ID), may be a slice aggregation ID, an algorithm ID, a multi-topology ID, or a virtual network ID, or may also be an application-associated identifier. The maximum reserved link bandwidth, that is, the maximum reservable link bandwidth, represents the maximum reservable link bandwidth of the specific slice.

FIG. 3B is a diagram illustrating another maximum reserved link bandwidth TLV according to an embodiment of the present application. Referring to FIG. 3B, the slice information is carried in the extended link attribute TLV, the resource information is carried in the sub-TLV of the extended link attribute TLV, the sub-TLV carries the maximum reserved link bandwidth TLV, the notification carries a sub-TLV format, and the specific slice is associated with the maximum reserved link bandwidth.

Two modes of carrying the maximum reservable link bandwidth of the specific slice are described in the preceding and are not limited.

Before the node notifies the controller of the maximum reservable link bandwidth associated with the specific slice/an application for the each link in the network through the BGP-LS protocol, the maximum reservable link bandwidth associated with the specific slice/application for the each link in the network needs to be acquired. The acquisition method is that each node in an IGP domain may notify other neighboring nodes of the maximum reservable link bandwidth of per slice of its local link (referring to local links that have activated the maximum reservable link bandwidth configuration of the per slice), locally save the maximum reservable link bandwidth of per slice of other remote links received from the neighboring nodes and continue to flood to the other neighboring nodes. In this way, a link-state database maintained by the each node in the IGP domain has the maximum reservable link bandwidth of per slice of all the links in the whole network.

### Embodiment Two

The node notifies the controller of used bandwidth information associated with a specific slice for the each link in the network through the BGP-LS protocol, such as the used bandwidth, also known as a used link bandwidth.

New link attribute TLVs are defined in the link NLRI for carrying the used bandwidth associated with the specific slice/an application.

FIG. 3C is a diagram illustrating a used bandwidth information TLV according to an embodiment of the present application. Referring to FIG. 3C, the slice ID may be a slice aggregation ID, an algorithm ID, a multi-topology ID or a virtual network ID, or may also be an application-associated identifier. The used link bandwidth represents the used link bandwidth of the specific slice.

Referring to FIG. 3C, the used bandwidth information TLV according to this embodiment of the present application is as shown in FIG. 3C. The sub-TLV carries the used link bandwidth, the notification carries a sub-TLV format, and the specific slice is associated with the used link bandwidth.

Two modes of carrying the used link bandwidth of the specific slice are described in the preceding and are not limited.

Before notifying the controller of the used bandwidth information, such as the used link bandwidth, associated with the specific slice/an application for the each link in the network through the BGP-LS protocol, the node needs to acquire the used bandwidth information associated with the specific slice/application for the each link in the network. The acquisition method is that each node in the network may perform statistics and measurement on the traffic that belongs to the specific slice and is forwarded on the each link, calculate and obtain the used bandwidth associated with the specific slice, notify other neighboring nodes of the used bandwidth information collected on its local link, locally save the used bandwidth information of other remote links received from the other neighboring nodes and then continue to flood to the other neighboring nodes. In this way, a link-state database maintained by the each node in the IGP domain has the used bandwidth information of all the links in the whole network.

### Embodiment Three

The node notifies the controller of available bandwidth information associated with a specific slice for the each link in the network through the BGP-LS protocol, such as the available bandwidth, also known as an available link bandwidth.

New link attribute TLVs are defined in the link NLRI for carrying the available bandwidth information associated with the specific slice/an application.

FIG. 3D is a diagram illustrating an available link bandwidth TLV according to an embodiment of the present application. Referring to FIG. 3D, the slice ID may be a slice aggregation ID, an algorithm ID, a multi-topology ID, or a virtual network ID, or may also be an application-associated identifier. The available link bandwidth represents the available link bandwidth of the specific slice.

Referring to FIG. 3D, the available link bandwidth TLV according to this embodiment of the present application is as shown in FIG. 3D. The sub-TLV carries the available link bandwidth, the notification carries a sub-TL V format, and the specific slice is associated with the available link bandwidth.

Two modes of carrying the available link bandwidth of the specific slice are described in the preceding and are not limited.

Before notifying the controller of the available link bandwidth associated with the specific slice for the each link in the network through the BGP-LS protocol, the node needs to acquire the available link bandwidth associated with the specific slice/an application for the each link in the network. The acquisition method is that the each node in the IGP domain calculates the available bandwidth information associated with the specific slice of the each local link for each local link and notifies the calculated available bandwidth information in the network.

The method for the each node in the IGP domain calculating the available bandwidth information associated with the specific slice of the each local link for each local link is that the maximum reserved link bandwidth of per slice/application minus the used link bandwidth of per slice/application.

### Embodiment Four

The node notifies the controller of the average link delay, the link packet loss rate, the maximum link delay information and the minimum link delay information associated with a specific slice for the each link in the network through the BGP-LS protocol.

New link attribute TLVs are defined in the link NLRI for carrying the average link delay, the link packet loss rate, the maximum link delay information and the minimum link delay information associated with the specific slice/an application.

### Embodiment Five

After receiving the resource information associated with the specific slice/application for the each link in the network, the controller maintains resource information conditions of a link of each specific slice/application. The resource information includes the maximum reserved link bandwidth of the link associated with the specific slice/application, the available bandwidth of the link associated with the specific slice/application, the used bandwidth of the link associated with the specific slice/application, the average link delay associated with the specific slice/application, the link packet loss rate associated with the specific slice/application and the maximum/minimum link delay associated with the specific slice/application. Moreover, when the network topological information changes, including the changes in the used bandwidth and the available bandwidth for the each link, the controller updates the resource information according to the collected information.

When link resource information conditions of each slice/application in the network need to be viewed, a query function can be supported.

When a new TE path (denoted as TE2) needs to be deployed for slice 1, a specific example is described below.

FIG. 3E is a diagram illustrating resource allocation according to an embodiment of the present application. Referring to FIG. 3E, two slices 1 (solid line in the figure) and 2 (dotted line in the figure) are created. Slice 1 contains nodes S, A, B and D as well as bidirectional links connected between these nodes. Slice 2 contains nodes S, B, C and D as well as bidirectional links connected between these nodes. Slice 1 and slice 2 share link 1 and link 2. It is assumed that the physical bandwidth of link 1 is 100 G, the maximum reserved bandwidth allocated to slice 1 is 70 G, and the maximum reserved bandwidth allocated to slice 2 is 30 G. There is already a TE path 1 from S to D (the reserved bandwidth is 10 G) inside slice 1. A new TE path 2 from S to D needs to be created inside slice 1 now, and 20 G needs to be reserved for this path.

The controller needs to select a link after a comprehensive analysis. One of the key selection conditions is that the available bandwidth of slice 1 of the link is greater than or equal to the reserved bandwidth requirement of TE 2. After the comprehensive analysis, when the controller determines to let TE2 pass through link 1, and TE2 of slice 1 starts to carry traffic, Table 1 describes a controller maintenance information table according to the embodiment of the present application. Referring to Table 1, the controller maintains the resource information of slice 1 and slice 2.

TABLE 1
Controller maintenance information table in
the embodiment of the present application

| Link | Slice Identifier | Bandwidth | | |
|---|---|---|---|---|
| Link 1 | Slice 1 | Maximum | Used | Available |
| | | reserved | bandwidth | bandwidth |
| | | bandwidth of | of slice | of slice |
| | | slice 1 = 70 G | 1 = 30 G | 1 = 40 G |
| | Slice 2 | Maximum | Used | Available |
| | | reserved | bandwidth | bandwidth |
| | | bandwidth of | of slice | of slice |
| | | slice 2 = 30 G | 2 = 0 G | 2 = 30 G |

In the present application, the node notifies the controller of the resource information associated with the specific slice for the each link in the network through the BGP-LS protocol.

The resource information includes at least one of: the maximum reserved link bandwidth of the link associated with the specific slice, the available bandwidth of the link associated with the specific slice/application, the used bandwidth of the link associated with the specific slice, the average link delay associated with the specific slice/application, the link packet loss rate associated with the specific slice/application, or the maximum/minimum link delay associated with the specific slice/application.

New link attribute TLVs are defined in the link NLRI for carrying the resource information associated with the specific slice.

Before notifying the controller of the resource information associated with the specific slice for the each link in the network through the BGP-LS protocol, the node needs to acquire the resource information associated with the specific slice/application for the each link in the network.

After receiving the resource information associated with the specific slice/application for the each link in the network, the controller maintains the resource information of the link of the each specific slice/application.

The resource information includes: the maximum reserved link bandwidth of the link associated with the specific slice/application, the available bandwidth of the link associated with the specific slice, the used bandwidth of the link associated with the specific slice/application, the average link delay associated with the specific slice/application, the link packet loss rate associated with the specific slice and the maximum/minimum link delay associated with the specific slice/application.

When the network topological information changes, including the changes in the used bandwidth and available bandwidth for the each link, the controller updates the information maintained by the controller according to the collected information.

In an exemplary embodiment, the present application provides an information transmission apparatus. FIG. 4 is a diagram illustrating the structure of an information transmission apparatus according to an embodiment of the present application. The apparatus may be configured in a network node. As shown in FIG. 4, the apparatus includes an acquisition module 41 configured to acquire slice-associated resource information for each link in a network and a transmission module 42 configured to transmit the resource information.

The information transmission apparatus according to this embodiment is configured to perform the information transmission method shown in FIG. 1. The information transmission apparatus according to this embodiment has implementation principles and technical effects similar to the information transmission method shown in FIG. 1. Details are not repeated here.

Based on the preceding embodiment, variant embodiments of the preceding embodiment are provided. It is to be noted here that for ease of description, only differences from the preceding embodiment are described in the variant embodiments.

In an embodiment, the resource information includes at least one of: a maximum reserved link bandwidth, an available bandwidth, a used bandwidth, an average link delay, a link packet loss rate, a maximum link delay, or a minimum link delay.

In an embodiment, the resource information is associated with slice information.

In an embodiment, the slice information includes at least one of: a slice aggregation identifier, an algorithm identifier, a multi-topology identifier, or a virtual network identifier.

In an embodiment, the resource information and the slice information are carried in a link attribute TLV extended in link network-layer reachability information (NLRI).

In an embodiment, the slice information is carried in the link attribute TLV extended in the link NLRI, and the resource information is carried in a sub-TLV of the link attribute TLV extended in the link NLRI.

In an embodiment, the apparatus further includes a retransmission module configured to, in the case where network topological information changes, acquire changed resource information and transmit the changed resource information.

In an exemplary embodiment, the present application provides an information transmission apparatus. FIG. 5 is a diagram illustrating the structure of another information transmission apparatus according to an embodiment of the present application. The apparatus may be configured in a controller. As shown in FIG. 5, the apparatus includes an acquisition module 51 configured to acquire slice-associated resource information for each link in a network and a storage module 52 configured to store the resource information.

The information transmission apparatus according to this embodiment is configured to perform the information transmission method shown in FIG. 3. The information transmission apparatus according to this embodiment has implementation principles and technical effects similar to the information transmission method shown in FIG. 3. Details are not repeated here.

Based on the preceding embodiment, variant embodiments of the preceding embodiment are provided. It is to be noted here that for ease of description, only differences from the preceding embodiment are described in the variant embodiments.

In an embodiment, the apparatus further includes an updating module configured to acquire changed resource information, and update the stored resource information according to the changed resource information.

In an embodiment, the apparatus further includes a first searching module configured to acquire a query request and search for resource information corresponding to the query request.

In an embodiment, the apparatus further includes a second searching module configured to acquire a deployment request, search for resource information corresponding to the deployment request and complete resource allocation based on the searched resource information.

In an embodiment, the resource information includes at least one of: a maximum reserved link bandwidth, an available bandwidth, a used bandwidth, a link delay, a link packet loss rate, a maximum link delay, or a minimum link delay.

In an embodiment, the resource information is associated with slice information.

In an embodiment, the slice information includes at least one of: a slice aggregation identifier, an algorithm identifier, a multi-topology identifier, or a virtual network identifier.

In an embodiment, the resource information and slice information are carried in a link attribute TLV extended in link network-layer reachability information (NLRI).

In an embodiment, the slice information is carried in the link attribute TLV extended in the link NLRI, and the resource information is carried in a sub-TLV of the link attribute TLV extended in the link NLRI.

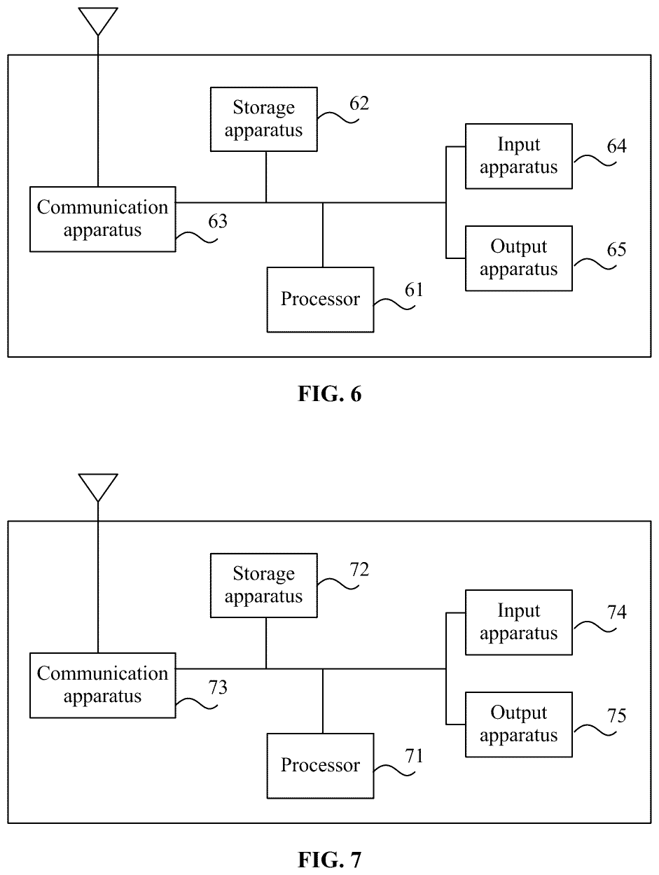

In an exemplary embodiment, an embodiment further provides a network node. FIG. 6 is a diagram illustrating the structure of a network node according to an embodiment of the present application. As shown in FIG. 6, the network node according to the present application includes one or more processors 61 and a storage apparatus 62. One or more processors 61 may be provided in the network node. One processor 61 is used as an example in FIG. 6. The storage apparatus 62 is configured to store one or more programs. When executed by the one or more processors 61, the one or more programs cause the one or more processors 61 to perform the information transmission method in the embodiment of the present application.

The network node further includes a communication apparatus 63, an input apparatus 64 and an output apparatus 65.

The one or more processors 61, the storage apparatus 62, the communication apparatus 63, the input apparatus 64 and the output apparatus 65 in the network node may be connected via a bus or other manners, with connection via the bus as an example in FIG. 6.

The input apparatus 64 may be configured to receive input digital or character information and generate key signal input related to user settings and function control of the network node. The output apparatus 65 may include a display device such as a display screen.

The communication apparatus 63 may include a receiver and a sender. The communication apparatus 63 is configured to perform information transceiving communication under the control of the processor 61. The information includes, but is not limited to, resource information.

As a computer-readable storage medium, the storage apparatus 62 may be configured to store software programs, computer-executable programs and modules, such as program instructions/modules (such as the acquisition module 41 and the transmission module 42 in the information transmission apparatus) corresponding to the information transmission method described in FIG. 1 of the embodiment of the present application. The storage apparatus 62 may include a program storage region and a data storage region. The program storage region may store an operating system and an application program required by at least one function. The data storage region may store data created depending on use of the network node. In addition, the storage apparatus 62 may include a high-speed random-access memory and may further include a nonvolatile memory such as at least one disk memory, a flash memory, or another nonvolatile solid-state memory. In some examples, the storage apparatus 62 may further include memories remotely disposed with respect to the processor 61. These remote memories may be connected to the network node via a network. Examples of the preceding network include, but are not limited to, the Internet, an intranet, a local area network, a mobile communication network and a combination thereof.

In an exemplary embodiment, an embodiment further provides a controller. FIG. 7 is a diagram illustrating the structure of a controller according to an embodiment of the present application. As shown in FIG. 7, the controller according to the present application includes one or more processors 71 and a storage apparatus 72. One or more processors 71 are provided in the controller. One processor 71 is used as an example in FIG. 7. The storage apparatus 72 is configured to store one or more programs. When executed by the one or more processors 71, the one or more programs cause the one or more processors 71 to perform the information transmission method in the embodiment of the present application.

The controller further includes a communication apparatus 73, an input apparatus 74 and an output apparatus 75.

The one or more processors 71, the storage apparatus 72, the communication apparatus 73, the input apparatus 74 and the output apparatus 75 in the controller may be connected via a bus or other manners, with connection via the bus as an example in FIG. 7.

The input apparatus 74 may be configured to receive input digital or character information and generate key signal input related to user settings and function control of the controller. The output apparatus 75 may include a display device such as a display screen.

The communication apparatus 73 may include a receiver and a sender. The communication apparatus 73 is configured to perform information transceiving communication under the control of the processor 71. The information includes, but is not limited to, resource information.

As a computer-readable storage medium, the storage apparatus 72 may be configured to store software programs, computer-executable programs and modules, such as program instructions/modules (such as the acquisition module 51 and the storage module 52 in the information transmission apparatus) corresponding to the information transmission method described in FIG. 3 of the embodiment of the present application. The storage apparatus 72 may include a program storage region and a data storage region. The program storage region may store an operating system and an application program required by at least one function. The data storage region may store data created depending on the use of the controller. In addition, the storage apparatus 72 may include a high-speed random-access memory and may further include a nonvolatile memory such as at least one disk memory, a flash memory, or another nonvolatile solid-state memory. In some examples, the storage apparatus 72 may further include memories remotely disposed with respect to the processor 71, and these remote memories may be connected to the controller via a network. Examples of the preceding network include, but are not limited to, the Internet, an intranet, a local area network, a mobile communication network and a combination thereof.

An embodiment of the present application further includes a storage medium storing a computer program which, when executed by a processor, causes the processor to perform any method of the present application. The storage medium stores a computer program which, when executed by a processor, causes the processor to perform any information transmission method according to embodiments of the present application, such as the information transmission method applied to a network node and the information transmission method applied to a controller.

The information transmission method applied to the network node includes that slice-associated resource information for each link in a network is acquired and transmitted.

The information transmission method applied to the controller includes that slice-associated resource information for each link in a network is acquired and stored.

A computer storage medium in an embodiment of the present application may use any combination of one or more computer-readable media. The computer-readable media may be computer-readable signal media or computer-readable storage media. A computer-readable storage medium may be, but is not limited to, an electrical, magnetic, optical, electromagnetic, infrared, or semiconductor system, apparatus, or element, or any combination thereof. More specific examples of the computer-readable storage medium (non-exhaustive list) include: an electrical connection having one or more wires, a portable computer magnetic disk, a hard disk, a random-access memory (RAM), a read-only memory (ROM), an erasable programmable read-only memory (EPROM), a flash memory, an optical fiber, a portable compact disc read-only memory (CD-ROM), an optical memory, a magnetic memory, or any suitable combination thereof. The computer-readable storage medium may be any tangible medium including or storing a program. The program may be used by or used in conjunction with an instruction execution system, apparatus, or device.

A computer-readable signal medium may include a data signal propagated in a baseband or as part of a carrier. The data signal carries computer-readable program codes. The data signal propagated in this manner may be in multiple forms and includes, but is not limited to, an electromagnetic signal, an optical signal, or any suitable combination thereof. The computer-readable signal medium may also be any computer-readable medium other than the computer-readable storage medium. The computer-readable medium may send, propagate, or transmit a program used by or used in conjunction with an instruction execution system, apparatus, or device.

Program codes included on the computer-readable medium may be transmitted by any suitable medium including, but not limited to, a wireless medium, a wire, an optical cable, a radio frequency (RF), or any suitable combination thereof.

Computer program codes for performing the operations of the present application may be written in one or more programming languages or a combination thereof. The programming languages include object-oriented programming languages such as Java, Smalltalk, C++, as well as conventional procedural programming languages such as “C” or similar programming languages. The program codes may be executed entirely on a user computer, executed partly on a user computer, executed as a stand-alone software package, executed partly on a user computer and partly on a remote computer, or executed entirely on a remote computer or a server. In the case relating to a remote computer, the remote computer may be connected to a user computer via any kind of network including a local area network (LAN) or a wide area network (WAN), or may be connected to an external computer (for example, via the Internet through an Internet service provider).

The preceding are only example embodiments of the present application and are not intended to limit the scope of the present application.

Generally speaking, embodiments of the present application may be implemented in hardware or special-purpose circuits, software, logic, or any combination thereof. For example, some aspects may be implemented in hardware while other aspects may be implemented in firmware or software executable by a controller, a microprocessor, or another computing apparatus, though the present application is not limited thereto.

Embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, status setting data, or source or object codes written in any combination of one or more programming languages.

A block diagram of any logic flow among the drawings of the present application may represent program steps, may represent interconnected logic circuits, modules, and functions, or may represent a combination of program steps and logic circuits, modules, and functions. Computer programs may be stored on a memory. The memory may be of any type suitable for the local technical environment and may be implemented by using any suitable data storage technology, such as, but not limited to, a ROM, a RAM, an optical storage device and system (a digital video disc (DVD) or a compact disc (CD)), and the like. Computer-readable media may include non-transitory storage media. The data processor may be of any type suitable for the local technical environment, such as, but not limited to, a general-purpose computer, a special-purpose computer, a microprocessor, a digital signal processor (DSP), an application-specific integrated circuit (ASIC), a field-programmable gate array (FPGA), and a processor based on a multi-core processor architecture.

1. An information transmission method, the method being applied to a network node and comprising:
acquiring slice-associated resource information for each link in a network; and
transmitting the resource information;
wherein the resource information comprises at least one of:
a maximum reserved link bandwidth, an available bandwidth, a used bandwidth, an average link delay, a link packet loss rate, a maximum link delay, or a minimum link delay.

2. (canceled)

3. The method according to claim 1, wherein the resource information is associated with slice information.

4. The method according to claim 3, wherein the slice information comprises at least one of:
a slice aggregation identifier, an algorithm identifier, a multi-topology identifier, or a virtual network identifier.

5. The method according to claim 3, wherein the resource information and the slice information are carried in a link attribute type-length-value (TLV) extended in link network-layer reachability information (NLRI).

6. The method according to claim 3, wherein the slice information is carried in a link attribute TLV extended in link NLRI, and the resource information is carried in a sub-TLV of the link attribute TLV extended in the link NLRI.

7. The method according to claim 1, further comprising:
in a case where network topological information changes, acquiring changed resource information and transmitting the changed resource information.

8. An information transmission method, the method being applied to a controller and comprising:
acquiring slice-associated resource information for each link in a network; and
storing the resource information;
wherein the resource information comprises at least one of:
a maximum reserved link bandwidth, an available bandwidth, a used bandwidth, an average link delay, a link packet loss rate, a maximum link delay, or a minimum link delay.

9. The method according to claim 8, further comprising:
acquiring changed resource information; and
updating the stored resource information according to the changed resource information.

10. The method according to claim 8, further comprising:
acquiring a query request; and
searching for resource information corresponding to the query request.

11. The method according to claim 8, further comprising:
acquiring a deployment request;
searching for resource information corresponding to the deployment request; and
completing resource allocation based on the searched resource information.

12. (canceled)

13. The method according to claim 8, wherein the resource information is associated with slice information.

14. The method according to claim 13, wherein the slice information comprises at least one of:
a slice aggregation identifier, an algorithm identifier, a multi-topology identifier, or a virtual network identifier.

15. The method according to claim 13, wherein the resource information and the slice information are carried in a link attribute type-length-value (TLV) extended in link network-layer reachability information (NLRI).

16. The method according to claim 13, wherein the slice information is carried in a link attribute TLV extended in link NLRI, and the resource information is carried in a sub-TL V of the link attribute TL V extended in the link NLRI.

17-18. (canceled)

19. A network node, comprising:
at least one processor; and
a storage apparatus configured to store at least one program,
wherein when executed by the at least one processor, the at least one program causes the at least one processor to:
acquire slice-associated resource information for each link in a network; and
transmit the resource information;
wherein the resource information comprises at least one of:
a maximum reserved link bandwidth, an available bandwidth, a used bandwidth, an average link delay, a link packet loss rate, a maximum link delay, or a minimum link delay.

20. A controller, comprising:
at least one processor; and
a storage apparatus configured to store at least one program,
wherein when executed by the at least one processor, the at least one program causes the at least one processor to perform the method according to claim 8.

21. A non-transitory storage medium storing a computer program which, when executed by a processor, causes the processor to perform the method according to claim 1.

22. A non-transitory storage medium storing a computer program which, when executed by a processor, causes the processor to perform the method according to claim 8.

23. The network node according to claim 19, wherein the resource information is associated with slice information.

24. The network node according to claim 23, wherein the slice information comprises at least one of:
a slice aggregation identifier, an algorithm identifier, a multi-topology identifier, or a virtual network identifier.
